(19) United States
(12) Patent Application Publication
(10) Pub. No.: US 2005/0004326 A1
(43) Pub. Date: Jan. 6, 2005

(54) Polyaryletherketone polymer blends

(76) Inventor: Kenneth Malcolm Seargeant, Lancashire (GB)

Correspondence Address: NIXON & VANDERHYE, PC, 1100 N GLEBE ROAD, 8TH FLOOR, ARLINGTON, VA, 22201-4714, US

(21) Appl. No.: 10/493,612

(22) PCT Filed: Oct. 24, 2002
(86) PCT No.: PCT/GB02/04804

(30) Foreign Application Priority Data
Oct. 24, 2001 (GB) 0125618.9

(51) Int. Cl. C08L 71/12

(52) U.S. Cl. 525/474; 525/534

(57) ABSTRACT

A blend comprises a polyaryletherketone and a polysiloxane. The blend has improved properties, for example tough-ness compared to the polyaryletherketone alone. A method of preparing the blend and its uses are described.

This invention relates to polyaryletherketone polymer blends and particularly, although not exclusively, relates to blends comprising polyetheretherketone polymer.

Polyetheretherketone polymer is a semi-crystalline polymer and is widely regarded as the highest performance thermoplastic material currently available. It has a glass transition temperature of 143° C. and a melting temperature of 343° C.

The polymer may be used in a variety of applications including automotive components where many of its high performance properties are important. However, such components generally need to maintain high performance levels across a temperature range of from −40° C. to 150° C. In some situations, properties of polyetheretherketone polymer at temperatures within the range are inadequate and, consequently, other plastics materials may be used in preference to the polymer. In particularly, the inherent toughness of polyetheretherketone polymer in the temperature range may be disadvantageously low, potentially shortening useful lifetimes of components. Other properties which could be improved to make the polymer more attractive for use within the temperature range are elongation at break and impact resistance.

A significant problem with any approach for addressing the abovedescribed problems is associated with the fact that polyetheretherketone polymer has to be processed (e.g. injection moulded or extruded) at a very high temperature. For example, the barrel temperature of an injection moulder and cylinder heaters of extruders must be able to reach 400° C., the temperature at which it is advisable to carry out the processes.

It is an object of the present invention to address the abovedescribed problems.

According to a first aspect of the invention, there is provided a method of preparing a polymer formulation comprising subjecting a blend comprising a polyaryletherketone and a polysiloxane to a temperature wherein said polyaryletherketone melts; and allowing the blend to cool to ambient temperature.

It has been found that a polysiloxane can be blended with a polyaryletherketone with the resultant formulation having improved properties over the temperature range −40° C. to 150° C., compared to the same polyaryletherketone alone. For example, the toughness of the formulation may be improved over that of the polyaryletherketone as may the elongation at break. It is surprising that a formulation having such advantageous properties can be prepared since polyaryletherketones are themselves regarded as inherently very tough and so increasing their toughness is a significant achievement. Furthermore, it is surprising that polysiloxanes can be satisfactorily blended with polyaryletherketones at the high temperatures at which polyaryletherketones melt, without apparent decomposition or other detrimental effects on their properties.

Said polyaryletherketone is preferably semi-crystalline. It preferably has a crystallinity of at least 20%, preferably at least 25%, more preferably at least 30%. The crystallinity may be less than 50%, preferably less than 40%. Crystallinity may be assessed by wide angle x-ray diffraction. (also referred to as Wide Angle X-ray Scattering or WAXS) for example as described by Blundell and Osborn (Polymer 24, 953, 1983).

Said polyaryletherketone suitably has a viscosity measured, using melt rheometry, at 380° C. with a shear applied of 500 s⁻¹ of at least 150 Pa.s, preferably at least 175 Pa.s, more preferably at least 200 Pa.s, especially at least 225 Pa.s. The viscosity as aforementioned may be less than 300 Pa.s, preferably less than 250 Pa.s.

When the viscosity of the polyaryletherketone is relatively high the polyaryletherketone selected for incorporation into said blend may be relatively fine—it may comprise a powder. When the viscosity is relatively low, it may be advantageous to select a polyaryletherketone which is granular. For example, when the viscosity measured as aforementioned is greater than 175 Pa.s (more preferably when it is greater than 200 Pa.s) the number mean diameter of polyaryletherketone particles selected for incorporation in the blend may be less than 1 mm, preferably less than 0.5 mm, more preferably less than 0.2 mm. When the viscosity measured as aforementioned is less than 200 Pa.s, (more preferably when it is less than 175 Pa.s), the number mean diameter of polyaryletherketone particles selected for incorporation in the blend may be greater than 0.2 mm, preferably greater than 0.5 mm, more preferably greater than 1 mm.

Said polyaryletherketone suitably has a melting point (peak of endotherm) measured by DSC of at least 300° C., preferably at least 325° C., more preferably at least 335° C. Said melting point is preferably less than 400° C., preferably less than 375° C., more preferably less than 350° C.

Said polyaryletherketone suitably has a glass transition temperature (Tg) measured by DSC of at least 100° C., preferably at least 125° C., more preferably at least 135° C., especially at least 140° C. The glass transition temperature may be less than 200° C., preferably less than 175° C., more preferably less than 150° C., especially less than 145° C.

Said polyaryletherketone suitably has a tensile strength measured at 23° C. according to ISOR527 of at least 80 MPa, preferably at least 90 MPa, more preferably at least 95 MPa. Said tensile strength may be less than 150 MPa, preferably less than 125 MPa, more preferably less than 100 MPa, especially less than 105 MPa.

Said polyaryletherketone may be selected from the group comprising: polyetheretherketone, polyetherketone, polyetherketoneketone, polyetherketoneetherketoneketone and polyetheretherketoneketone. Preferably said polyaryletherketone is selected from: polyetheretherketone and polyetherketone. More preferably, said polyaryletherketone is polyetheretherketone. Preferably, only a single polyaryletherketone is provided in said polymer formulation.

Said polysiloxane may be a silsesquioxane. Said polysiloxane may be di-substituted by C₁₋₄ alkyl groups and/or phenyl groups. Preferred C₁₋₄ alkyl groups are methyl groups. Said polysiloxane is preferably a polydimethylsiloxane.

Said polysiloxane is preferably not substituted with groups which may interfere with, for example substantially disrupt, the crystal lattice of the polyaryletherketone when the polyaryletherketone and polysiloxane are in a blend. The polysiloxane may optionally be substituted with functional groups. In this case the functional groups are preferably such that they may be exchanged with ether groups in a polyaryletherketone crystal lattice. Functional groups that may do this include epoxy groups. In preferred embodiments, the polysiloxane is not substituted with alkoxy, for example methoxy groups. In preferred embodiments, said polysiloxane is either unsubstituted or is substituted by epoxy groups.

Said polysiloxane may include means adapted to increase its compatibility with the polyaryletherketone. Such means may include organo-reactive sites, for example epoxy compatible sites. Thus, said polysiloxane may include attached organo-reactive sites, especially attached epoxy compatible sites.

Said polysiloxane is preferably an ultra high molecular weight polysiloxane. Said polysiloxane may have a number average molecular weight of at least 100,000, suitably at least 250,000, preferably at least 500,000. The molecular weight of said polysiloxane may be 1,000,000 or more.

Said polysiloxane preferably has a viscosity (e.g. at 380° C. and a shear rate of 500 s⁻¹) of less than the viscosity of the polyaryletherketone. The ratio of the viscosity of the polyaryletherktone to the polysiloxane (e.g. at 380° C. and a shear rate of 500 s⁻¹) is preferably greater than 1.1, more preferably greater than 1.2. Said ratio may be less than 3.

The temperature at which decomposition of the polysiloxane starts may be less than the temperature at which decomposition of the polyaryletherketone starts. The difference between the temperature at which decomposition of the polyaryletherketone starts and the temperature at which decomposition of the polysiloxane starts may be greater than 50° C. or even greater than 75° C.

In a preferred embodiment, the polymer formulation prepared in the method may comprise two distinct phases. The two phases may be observed by electron microscopy. Preferably, said polysiloxane is substantially insoluble in said polyaryletherketone and this suitably allows production of the two phases. Preferably, in the polymer formulation prepared in the method, the polysiloxane appears, when analysed using SEM, as well dispersed droplets. The droplets may have average diameters of less than 100 μm, preferably less than 50 μm, more preferably less than 25 μm, especially less than 10 μm. The average diameter may be greater than 1 μm.

Preferably, said polymer formulation includes polysiloxane in a substantially spherical form.

In the method, said blend is suitably subjected to a temperature of at least 340° C., preferably at least 350° C., more preferably at least 360° C., especially at least 370° C. In some cases, the temperature may be 380° C. or greater. Such high temperatures are needed to melt the polyaryletherketone. The blend may be held at a temperature as aforesaid for less than 60 minutes, preferably less than 45 minutes, especially less than 30 minutes.

Preferably, whilst subjected to said temperature, said blend may be shaped into a desired form. Preferably, said blend is shaped by moulding, (e.g. by injection or compression moulding) or extrusion. Suitably, therefore, said blend is subjected to said temperature in an injection moulding or extrusion apparatus. After injection moulding or extrusion, said desired form of said blend may be allowed to cool to ambient temperature.

Said desired form of said blend prepared in the method preferably has a toughness, assessed using a Moulded Notched Sensitivity Test at ambient temperature as described in ASTM D256-97, which is greater than the toughness of a comparative product formed from the same polyaryletherketone, but excluding any polysiloxane.

Said desired form of said blend prepared in the method preferably has a tensile elongation at break assessed at 23° C. according to ISOR527, which is greater than the elongation at break of a comparative product formed from the same polaryletherketone, but excluding any polysiloxane.

Said blend comprising a said polyaryletherketone and a said polysiloxane may be prepared by contacting said polyaryletherketone and said polysiloxane at a temperature of less than 100° C., preferably at less than 50° C., more preferably at ambient temperature. Preferably, said polysiloxane, in a solid form, is contacted with said polyaryletherketone, suitably also in a solid form. Said polysiloxane referred to could include an active ingredient (a polysiloxane) in association with a carrier adapted to facilitate handling of the polysiloxane and/or enable it to be provided in a solid form, for example as a powder. A preferred said carrier may be a fumed silica. Up to 55 wt %, for example up to 50 wt % of said polysiloxane may comprise a carrier as described.

After contact of said polyaryletherketone and said polysiloxane, the materials may be mixed, suitably at ambient temperature, for example by tumble blending.

If desired the blend may be subjected to said temperature and thereafter formed into granules (or the like) which can be allowed to cool to ambient temperature and then used as a feedstock for subsequent extrusion, injection moulding (or the like).

According to a second aspect of the invention, there is provided a polymer formulation prepared in a method according to the first aspect.

According to a third aspect of the invention, there is provided a polymer formulation comprising a polyaryletherketone and a polysiloxane.

The polymer formulation may have any feature as described according to the first aspect. Preferably, said formulation comprises polyetheretherketone and a said polysiloxane.

Said formulation may include at least 50 wt %, suitably at least 60 wt %, preferably at least 70 wt %, more preferably at least 60 wt %, especially at least 90 wt % of polyaryletherketone. The amount of polyaryletherketone may be less than 98 wt %, preferably less than 95 wt %. Said formulation may include at least 1 wt %, preferably at least 2 wt %, more preferably at least 4 wt %, especially at least 6 wt % of polysiloxane. The amount of polysiloxane may be 20 wt % or less, preferably 15 wt % or less.

Preferably, the amount and identity of the polysiloxane are selected so that the ratio of the toughness of said polymer formulation to the toughness of the polyaryletherketone component of the formulation per se is at least 1.5, preferably at least 2, more preferably at least 4, preferably at least 8, especially at least 10, wherein the toughness is assessed as described in ASTM D256-97

According to a fourth aspect of the invention, there is provided an engineering or electrical component, said component comprising a polymer formulation according to the third aspect.

A said engineering component may be a gear. A said engineering component may be for an automotive application. A said electrical component may be an electrical insulator for example a coating for wire.

According to a fifth aspect of the invention, there is provided a method of manufacturing an engineering or electrical component, the method comprising extruding or injection moulding a polymer formulation according to said third aspect.

Any feature of any aspect of any invention or embodiment described herein may be combined with any feature of any aspect of any other invention or embodiment described herein mutates mutandis.

Specific embodiments of the invention will now be described, by way of example.

The following products are referred to hereinafter:

Dow 4-7051 UHMW Siloxane—an ultra high molecular weight powdered polysiloxane comprising, as the main component, polydimethyl silsioxane having epoxy reactivity obtained from Dow Corning Corporation.

Dow E-604—a siloxane containing polydimethyl silsesquioxane as the main component, obtained from Dow Corning Corporation.

Dow 4-7105 UHMW Siloxane—an ultra high molecular weight powdered unmodified polysiloxane.

PEEK™150P —a low melt viscosity polyetheretherketone obtained from Victrex Plc, UK. The polymer has a viscosity of 150 Pa.s, measured at a shear rate of 1000 s⁻¹ at a temperature of 400° C.

PEEK™380P—a medium melt viscosity polyetheretherketone obtained from Victrex Plc, UK. The polymer has a viscosity of 380 Pa.s, measured at a shear rate of 1000 s⁻¹ at a temperature of 400° C.

PEEK™450P—a standard melt viscosity polyetheretherketone obtained from Victrex Plc, UK. The polymer has a viscosity of 450 Pa.s, measured at a shear rate of 1000 s⁻¹ at a temperature of 400° C.

PEEK™151G—a low melt viscosity polyetheretherketone presented in granular form.

### EXAMPLE 1

### General Process for Preparation of Materials

### EXAMPLE 1(a)

### Preparation of Granules of Blends

Powdered polyetheretherketone and powdered polysiloxane were tumble blended at ambient temperature prior to addition to a hopper from which the blend was made into granules by processing the blend at a temperature conventionally used for processing polyetheretherketone (e.g. at about 400° C.).

### EXAMPLE 1(b)

### Preparation of Test Pieces

The granules formed in Example 1(a) were injected moulded at a conventional temperature for injection moulding polyetheretherketone (about 400° C.) and formed into appropriate shapes for carrying out desired tests.

Test Pieces “A” were made generally as described in ASTM D256-97 wherein a notch was moulded in as a result of the shape of the mould. The section thickness was 3 mm, the depth of the sample 12.7 mm and the notch formed so that the remaining depth was 9.5 mm.

Test Pieces “B” were made from a 10 mm*4 mm bar which was cut using a standard notching tool according to ISO 180:1993 standard.

### EXAMPLE 2—(COMPARATIVE) AND EXAMPLES 3 TO 8

### Moulded Notched Sensitivity Test of Blends

Blends for Examples 3 to 8 were prepared as described in Example 1 except that differing levels of the siloxane (Dow 4-7501) were included as shown in Table 1, together with PEEK™ 450P. Samples of the materials, in the form of Test Pieces A described above, were then subjected to a Moulded Notched Sensitivity Test at ambient temperature generally as described in ASTM D256-97 to assess their toughness. Results are provided in Table 1. For comparison purposes, polyetheretherketone, in the absence of any siloxane, was tested (Example 2).

TABLE 1

| Example No | 2 | 3 | 4 | 5 | 6 | 7 | 8 |
|---|---|---|---|---|---|---|---|
| Siloxane | 0 | 2 | 4 | 6 | 8 | 10 | 15 |
| (wt %) | | | | | | | |
| Energy J/m | 43 | 46 | 79 | 363 | >600 | >600 | >600 |

It will be appreciated from the table that even relatively low levels of siloxanes provide significant improvements in toughness.

### EXAMPLES 9 TO 17

By a process similar to that described for examples 2 to 8, blends were prepared using a siloxane selected from Dow E-604, Dow 4-7105 and Dow 4-7081 together with PEEK™450P at various levels and tests undertaken as described. Results are provided in Table 2,

TABLE 2

| | Example No | | | | | | | | |
|---|---|---|---|---|---|---|---|---|---|
| | 9 | 10 | 11 | 12 | 13 | 14 | 15 | 16 | 17 |
| Silox- | Dow | Dow | Dow | Dow | Dow | Dow | Dow | Dow | Dow |
| ane | E- | E- | E- | 4- | 4- | 4- | 4- | 4- | 4- |
| Type | 604 | 604 | 604 | 7105 | 7105 | 7105 | 7081 | 7081 | 7081 |
| Silox- | 1 | 5 | 10 | 4 | 6 | 10 | 4 | 6 | 10 |
| ane | | | | | | | | | |
| (wt %) | | | | | | | | | |
| Energy | 42 | 61 | 146 | 60 | 71 | >600 | 72 | 80 | 245 |
| J/M | | | | | | | | | |

### EXAMPLES 18 TO 27

### Izod Impact Testing at Various Temperatures

A blend was prepared as described in Example 1 comprising PEEK™450P and Dow 4-7501 (8 wt %) and the material formed into bars (Test Pieces B as described above) of dimensions 4 mm*10 mm which were cut with a standard notching tool according to ISO180:1993 standard. The samples were subjected to Izod impact testing (Rapra Test H0549) to assess their toughness. The results are provided in Table 3 which also details results of tests undertaken on PEEK™450P prepared as described but in the absence of any siloxane.

TABLE 3

| Example No | 18 | 19 | 20 | 21 | 22 | 23 |
|---|---|---|---|---|---|---|
| Temperature (° C.) | −40 | 0 | 23 | 50 | 100 | 150 |
| PEEK ™ 450P alone | 9.7 | 9.5 | 9.3 | 9.8 | 12.4 | 26.8 |
| (KJ/m²) | | | | | | |
| Blend (KJ/m²) | 26.6 | 29.6 | 37.9 | 70.1 | 82.6 | 81 |

It will be noted from Table 3 that the impact toughness of PEEK™450P alone does not start to increase significant until above 100° C. and does not approach the low temperature toughness of the blend until above a temperature of about 150° C.

### EXAMPLE 24 (COMPARATIVE) TO EXAMPLE 28

### Elongation Assessment

Blends prepared as described in Example 1 were tested to assess their elongation at 50 mm/min. The results are provided in Table 4 from which it will be noted that the elongation of the blends is either the same as or is improved compared to PEEK™450P in the absence of any siloxane.

TABLE 4

| Example No | 24 | 25 | 26 | 27 | 28 |
|---|---|---|---|---|---|
| Siloxane (wt %) | 0 | 4 | 6 | 8 | 15 |
| Elongation % | 23 | 23 | 30 | 36 | 41 |

### EXAMPLES 29 TO 31

### Effect of Viscosity of Polyetheretherketone on Morphology and Properties of Blends

Blends comprising PEEK™150P (Example 29), PEEK™380P (Example 30) and PEEK™450P (Example 31) together with Dow 4-7051 (8 wt %) were blended as described in Example 1 and their Izod Impact Energies measured as described above. The results are provided in Table 5 from which it will be noted that a tougher polymer is obtained starting from higher viscosity polyetheretherketones.

TABLE 5

| Example No | 29 | 30 | 31 |
|---|---|---|---|
| Izod J/m | 44 | 280 | >600 |

### EXAMPLE 32

### Comparison of Viscosities

A comparison of viscosities of PEEK™450P and Dow 4-7051 was made using melt rheometry at 380° C., the processing temperature of the polyetheretherketone. The results are provided in Table 6 from which it will be noted that the siloxane was of significantly lower viscosity compared to the PEEK™450P.

TABLE 6

| | Viscosity of | Viscosity of |
|---|---|---|
| Sheer Applied (s⁻¹) | siloxane (Pa · s) | PEEK ™ 450P (Pa · s) |
| 500 | 175 | 234 |
| 1000 | 102 | 240 |
| 1900 | 78 | 202 |
| 3100 | — | 175 |

Test samples were simply snapped and the fractured surfaces of materials described in Examples 29 to 31 examined by electron Microscopy. This showed that the grade of polyetheretherketone affected the morphology of the product.

For the material of Example 31, the siloxane was seen as well dispersed droplets of approximately 2-4 microns in diameter. From the surface of the droplets could be seen attached polymer deposits. The even distribution and attachment of the polymer might explain the significant toughness increase of the blend compared to polyetheretherketone alone.

For the material of Example 29, the siloxane could be seen as broken threads embedded in the polymer.

For the material of Example 30, it was difficult to establish the nature of the siloxane. There were particles that appeared to be discrete as opposed to broken rod like structures but there were also some broken rods. This may be explained on the basis that dispersion of siloxane in the polymer had not fully taken place due to inadequate mixing as a result of the viscosity difference of the components.

### EXAMPLES 33 AND 34

### Effect of Shear on Properties of Blends

Respective blends of PEEK™450P and Dow 4-7051 (8 wt %) were prepared generally as described in Example 1 except that a twin-screw extruder was used for Example 33 and a single screw extruder was used for Example 34. The Izod Impact Energy was assessed as described for Examples 29 to 31 and the results are provided in Table 7.

TABLE 7

| Example No | 33 | 34 |
|---|---|---|
| Izod J/m | >600 | 55 |

### EXAMPLE 35

### Effect of Powder Size on Properties of Blends

By processes analogous to the process of Example 1 the Izod Impact Energies of blends comprising 8% wt of Dow 4-7051 together with either powdered polyetheretherketone (PEEK™150P) or granular polyetheretherketone (PEEK™151G) were assessed. The Izod value (J/m) for the PEEK™150P blend was 44 J/m whereas the value for PEEK™151G was 70 J/m. Thus, for relatively low viscosity polyetheretherketones it may be advantageous to use granules rather than powders.

As illustrated above, blends of polyetheretherketone and silicones have an improved toughness, particularly within the temperature range −40° C. to 150° C. and, accordingly, are highly suitable for automotive applications. Blends may also be used in seals/joints between metal surfaces wherein sealing will be possible at lower pressures as the material will yield to conform to the less than perfect surfaces. Additionally, the advantageous increase in elongation of the blends may be utilised in applications such as wire coating to provide wires of potentially increased flexibility. Additionally, components made from blends were found to be whiter than expected and had an improved surface sheen. These properties may make the components more aesthetically acceptable.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extend to any novel one, or any novel combination, of the features disclosed in this specification (including any accompanying claims, abstract and drawings), or to any novel one, or any novel combination, of the steps of any method or process so disclosed.

1. A method of preparing a polymer formulation comprising subjecting a blend comprising a polyaryletherketone and a polysiloxane to a temperature wherein said polyaryletherketone melts; and allowing the blend to cool to ambient temperature.

2. A method according to claim 1, wherein said polyaryletherketone has a viscosity measured, using melt rheometry, at 380° C. with a shear applied of 500 s⁻¹ of at least 150 Pa.s.

3. A method according to claim 2, wherein said viscosity is at least 225 Pa.s.

4. A method according to claim 1, wherein the polyaryletherketone selected for incorporation in the polymer formulation has either:
(a) a viscosity of greater than 200 Pa.s⁻¹ and the number mean diameter of the polyaryletherketone particles selected is less than 1 mm; or
(b) a viscosity of less than 200 Pa.s⁻¹ and the number means diameter of the polyaryletherketone particles selected is greater than 1 mm;
wherein the viscosity is measured, using melt rheometry at 380° C. with a shear rate of 500 s⁻¹.

5. A method according to claim 1, wherein said polyaryletherketone has a melting point (peak of endotherm) measured by DSC of at least 300° C.

6. A method according to claim 1, wherein said polyaryletherketone is selected from the group comprising:
polyetheretherketone, polyetherketone, polyetherketoneketone, polyetherketoneetherketoneketone and polyetheretherketoneketone.

7. A method according to claim 1, wherein said polyaryletherketone is selected from polyetheretherketone and polyetherketone.

8. A method according to claim 1, wherein said polyaryletherketone is polyetheretherketone.

9. A method according to claim 1, wherein said polysiloxane is a polydimethylsiloxane.

10. A method according to claim 1, wherein said polysiloxane is not substituted with groups which may interfere with the crystal lattice of the polyaryletherketone.

11. A method according to claim 1, wherein the polysiloxane is optionally substituted with functional groups which are such that they may be exchanged with ether groups in a polyaryletherketone crystal lattice.

12. A method according to claim 1 wherein said polysiloxane is either unsubstituted or is substituted by epoxy groups.

13. A method according to claim 1, wherein said polysiloxane has a number average molecular weight of at least 100,000.

14. A method according to claim 1, wherein said polysiloxane has a viscosity of less than the viscosity of the polyaryletherketone.

15. A method according to claim 1, wherein the temperature at which decomposition of the polysiloxane starts is less than the temperature at which decomposition of the polyaryletherketone starts.

16. A method according to claim 1, wherein the difference between the temperature at which decomposition of the polyaryletherketone starts and the temperature at which decomposition of the polysiloxane starts is greater than 50° C.

17. A method according to claim 1, wherein the polymer formulation prepared in the method comprises two distinct phases.

18. A method according to claim 1, wherein said blend is subjected to a temperature of at least 340° C.

19. A method according to claim 1, wherein said blend is subjected to a temperature of at least 370° C.

20. A method according to claim 18, wherein, whilst subjected to said temperature, said blend is shaped into a desired form.

21. A method according to claim 20, wherein said desired form of said blend has a toughness, assessed using a Molded Notched Sensitivity Test at ambient temperature as described in ASTM B-256-97 which is greater than the toughness of a comparative product formed from the same polyaryletherketone, but excluding any polysiloxane.

22. A method according to claim 1, wherein said blend comprising a said polyaryletherketone and a said polysiloxane is prepared by contacting said polyaryletherketone and said polysiloxane at a temperature of less than 100° C.

23. A polymer formulation prepared in a method according to claim 1.

24. A polymer formulation comprising a polyaryletherketone and a polysiloxane.

25. A formulation according to claim 24, which comprises pclyetheretherketone and a said polysiloxane.

26. A formulation according to claim 25, which includes at least 80 wt % of polyaryletherketone.

27. A formulation according to claim 26, wherein the amount and identity of the polysiloxane are selected so that the ratio of the toughness of said polymer formulation to the toughness of the polyaryletherketone component of the formulation per se is at least 1.5 wherein the toughness is measured as described in ASTM D-256-97.

28. An engineering or electrical component, said component comprising a polymer formulation according to claim 24.

29. A method of manufacturing an engineering or electrical component, the method comprising extruding or injection moulding a polymer formulation according to claim 24.
